(19) United States
(12) Patent Application Publication
(10) Pub. No.: US 2017/0092399 A1
(43) Pub. Date: Mar. 30, 2017

(54) SEGMENTED PERMANENT MAGNETS

(71) Applicant: Ford Global Technologies, LLC, Dearborn, MI (US)

(72) Inventor: Wanfeng LI, Novi, MI (US)

(21) Appl. No.: 14/867,065

(22) Filed: Sep. 28, 2015

(51) Int. Cl. H01F 7/02; H01F 41/02; H01F 1/00

(52) U.S. Cl. CPC H01F 7/021; H01F 7/0231; H01F 1/00; H01F 41/0253

(57) ABSTRACT

A segmented magnet is disclosed comprising first and second layers of permanent magnetic material and an insulating layer therebetween. The insulating layer may include a rare earth element and a ceramic mixture including at least first and second ceramic materials. The ceramic materials may include a halogen and an alkaline earth metal, alkali metal, or a metal having a +3 or +4 oxidation state. The rare earth element may comprise up to 30 wt. % of the insulating layer. The segmented magnet may be formed by applying the insulating layer to a first sintered permanent magnet layer, stacking a second sintered permanent magnet layer in contact with the insulating layer and spaced from the first sintered permanent magnet layer, and heating the formed magnet stack. The heating step may include annealing the magnet stack at an annealing temperature within 100° C. of the melting point of the ceramic mixture.

### TECHNICAL FIELD

This disclosure relates to segmented magnets, for example Nd—Fe—B magnets.

### BACKGROUND

Permanent magnet motors are common, and may be used in electric vehicles. Due to the high conductivity of sintered Nd—Fe—B magnets and the slot/tooth harmonics, eddy current losses may be generated inside the magnets. This may increase the magnet temperature and can deteriorate the performance of the permanent magnets, which may lead to a corresponding reduction in efficiency of the motors. In an attempt to address these issues and to make the magnets work at elevated temperatures, high coercivity magnets may be used in motors. These magnets typically contain expensive heavy rare earth (HRE) elements, such as Tb and Dy. Reducing eddy current losses can improve the motor efficiency and the materials cost can be decreased.

### SUMMARY

In at least one embodiment, a segmented magnet is provided. The magnet may include a first layer of permanent magnetic material; a second layer of permanent magnetic material; and an insulating layer separating the first and second layers and including a rare earth element and a ceramic mixture including at least first and second ceramic materials.

The ceramic mixture may have a melting point that is lower than a melting point of each of the first and second ceramic materials. In one embodiment, the first or second ceramic material includes a compound having a formula of AH₂, where A is an alkaline earth metal and H is a halogen. In another embodiment, the first or second ceramic material includes a compound having a formula of MH₃, where M is metal having a +3 oxidation state and H is a halogen. In another embodiment, the first or second ceramic material includes a compound having a formula of BH, where B is an alkali metal and H is a halogen.

The ceramic mixture may have a melting point that is less than or equal to 1,000° C. The rare earth element may be part of a rare earth alloy or a rare earth compound. The rare earth alloy may include one or more of NdCu, NdAl, DyCu, NdGa, PrAl, PrCu, or PrAg. In one embodiment, the rare earth element may comprise up to 20 wt. % of the insulating layer. The permanent magnetic material in the first and second layers may be a Nd—Fe—B magnet and the rare earth element in the insulating layer may be Nd.

In at least one embodiment, a method of forming a segmented magnet is provided. The method may include applying an insulating layer to a first sintered permanent magnet layer, stacking a second sintered permanent magnet layer in contact with the insulating layer and spaced from the first sintered permanent magnet layer to form a magnet stack, and heating the magnet stack. The insulating layer may include a rare earth element and a ceramic mixture including at least first and second ceramic materials.

In one embodiment, the first and second ceramic materials may be selected from a group consisting of: a compound having a formula of AH₂, where A is an alkaline earth metal and H is a halogen; a compound having a formula of MH₃, where M is metal having a +3 oxidation state and H is a halogen; and a compound having a formula of BH, where B is an alkali metal and H is a halogen.

The ceramic mixture may have a melting point that is lower than a melting point of each of the first and second ceramic materials. The heating step may include annealing the magnet stack at an annealing temperature within 100° C. of the ceramic mixture melting point. The method may include applying pressure to the magnet stack during the heating step. The method may include sectioning the first and second sintered permanent magnet layers from a bulk sintered magnet prior to the applying step. In one embodiment, the rare earth element comprises up to 30 wt. % of the insulating layer.

In at least one embodiment, a segmented magnet is provided. The magnet may include a first layer of permanent magnetic material; a second layer of permanent magnetic material; and an insulating layer separating the first and second layers and including: a rare earth element and a ceramic mixture including at least two ceramic materials in a eutectic system. The ceramic mixture may have a melting point that is within 100° C. of a eutectic point temperature of the eutectic system. The eutectic system may be a binary, ternary, or quaternary system.

In one embodiment, at least one of the at least two ceramic materials is selected from a group consisting of: a compound having a formula of AH₂, where A is an alkaline earth metal and H is a halogen; a compound having a formula of MH₃, where M is metal having a +3 oxidation state and H is a halogen; and a compound having a formula of BH, where B is an alkali metal and H is a halogen.

### BRIEF DESCRIPTION OF THE DRAWINGS

FIG. 1 is a schematic example of a cross-section of a sintered magnet;

FIG. 2 is a demagnetization curve of a sintered Nd—Fe—B magnet;

FIG. 3 is a schematic of a method of forming a segmented magnet, according to an embodiment; and

FIG. 4 is an example of a binary phase diagram including a eutectic reaction for a mixture of CaF₂ and AlF₃.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

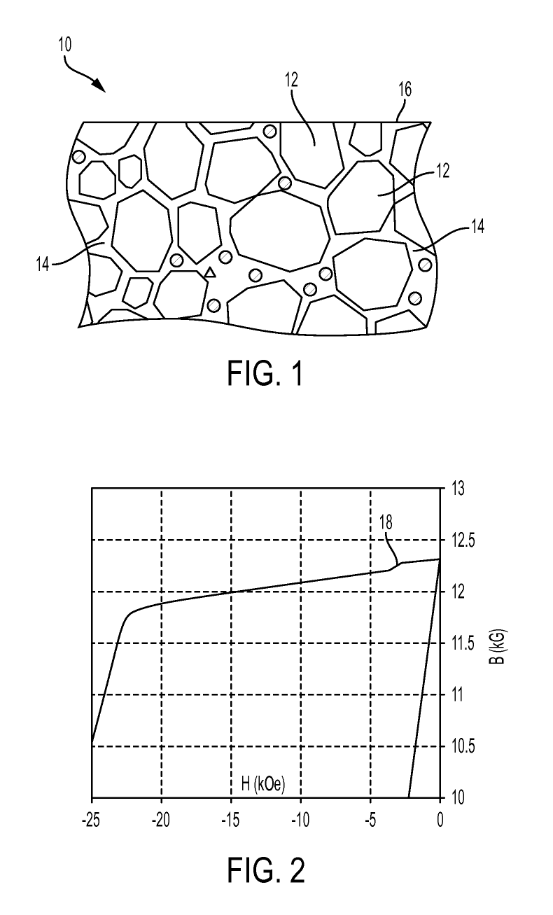

One approach to reducing eddy current losses is to cut or divide the magnet into smaller and thinner pieces, and then glue these segmented magnets into the desired sized magnet using resin or epoxy. To reduce the eddy current losses the thickness of each piece of segmented magnet should be as small as possible. However, this may give rise to a new issue of property degradation near the surface of the magnet. For sintered Nd—Fe—B magnets, it is known that the Nd rich phase is important to the coercivity of the magnet. An example cross-section of a magnet 10 is shown in FIG. 1. The magnet 10 includes grains 12, such as Nd₂Fe₁₄B grains, separated by grain boundaries 14. The grains near the surface 16 of the magnet tend to lack the Nd rich phase, and therefore tend to have much lower coercivity. When the magnet 10 is cut and/or ground into smaller pieces, defects are introduced into the newly created surfaces. These defects may include crystallographic defects, such as dangling bonds, impurities, and/or point defects, as well as larger or macro-scale defects, such as increased surface roughness and/or residue from the cutting/grinding process. In general, any mechanical damage to the magnet, and therefore the Nd₂Fe₁₄B lattice, will reduce the anisotropy field of the magnet (and therefore the coercivity).

As a result, there are typically kinks in the second quadrant in the hysteresis curves of sintered Nd—Fe—B magnets. Even for high quality magnets with heavy rare earth (HRE) elements, the kink can still be seen. An example is shown in FIG. 2, which is a demagnetization curve of a sintered Nd—Fe—B magnet of high coercivity. The magnitude of the kink 18 may vary based on the surface roughness and surface to volume ratio of the magnet. For a segmented magnet, due to the smaller thickness, there are many more grains exposed to a surface. These grains generally have significantly lower coercivity, which may cause a large kink in the second quadrant of the hysteresis curve. Therefore, the performance of the magnet can be considerably worse than a corresponding bulk magnet with the same composition and processing history.

The disclosed segmented permanent magnets, and methods of forming the same, may overcome the surface softness and damage of sintered and segmented Nd—Fe—B magnets, while still combining segmented magnets into a bulk sized magnet. The disclosed magnets and methods may increase the coercivity of the sintered Nd—Fe—B magnet and also combine the heat treatment and combination process into one step.

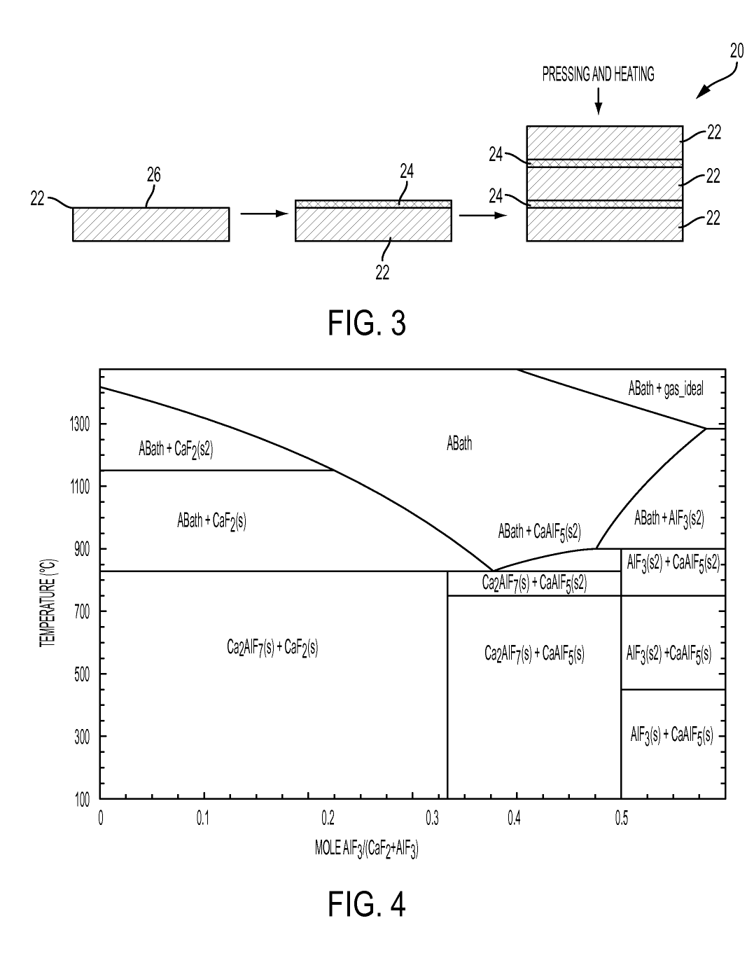

With reference to FIG. 3, a schematic method of forming a segmented magnet 20 is shown. A sintered bulk magnet may be cut or sectioned into smaller sintered magnet layers 22, similar to segmented magnets described above. Instead of joining the magnet layers 22 using an epoxy, however, insulating layers 24 may separate the magnet layers 22. As described in additional detail below, the insulating layers 24 may “heal” the damaged surfaces 26 of the magnet layers 22 created during sectioning. Accordingly, the surfaces 26 of the magnet layers 22 may have an improved anisotropy field, and therefore coercivity, compared to conventionally joined segmented magnets (e.g., using epoxy).

The magnetic layers 22 may be formed of any suitable hard or permanent magnetic material. In one embodiment, the magnetic material may include a rare earth (RE) element, such as neodymium or samarium. For example, the magnetic material may be a neodymium-iron-boron (Nd—Fe—B) magnet or a samarium-cobalt (Sm—Co) magnet. The specific magnetic material compositions may include Nd₂Fe₁₄B or SmCo₅, however, it is to be understood that variations of these compositions or other permanent magnet compositions may also be used. Other materials and/or elements may also be included in the magnetic material to improve the properties of the magnet (e.g., magnetic properties, such as coercivity), for example, heavy rare earth elements such as Y, Tb, Dy, Ho, Er, Tm, Yb, and Lu.

The insulating layers 24 may be formed of any suitable material having an electrical resistance greater than that of the magnetic layers 22. In one embodiment, the insulating layers 24 may include a ceramic material. One example of a material that has been tested is calcium fluoride (CaF₂). However, it has been found that insulating layers of CaF₂ must be made relatively thick to provide adequate resistance. But, thick layers of CaF₂ result in a magnet having poor mechanical properties, which may be due to the relatively high melting point of CaF₂, higher both the typical sintering and annealing temperatures of Nd—Fe—B magnets.

It has been discovered that mixtures of ceramic materials may be used in the insulating layers 24, which may have lower melting points than the constituent ceramics. These mixtures may utilize eutectic reactions. Although the ceramics tend to have high melting points, the eutectic reaction between ceramics can significantly decrease the melting point of a ceramic mixture. Even if the overall composition of the mixture of a system is not at or near the eutectic point, at the surface of the particles of the mixture the melting point can be significantly reduced. For the densification process of ceramics, formation of a liquid phase can enhance the densification rate, and therefore increase the cohesive force of the insulating layers. In liquid phase sintering, materials transport is much faster through a continuous liquid grain boundary film, assisted by capillary forces arising from voids in the liquid that resides in inter-particle interstices. Furthermore, increasing volume of liquid phase during sintering can also improve the interaction between the magnet and the insulating layers.

In one embodiment, the insulating layers 24 may include a mixture (e.g., two or more) of compounds including an alkaline earth metal and a halogen. These compounds may have a formula of AH₂, such as difluorides, where A is an alkaline earth metal and H is a halogen. The alkaline earth metals may include beryllium (Be), magnesium (Mg), calcium (Ca), strontium (Sr), barium (Ba), and radium (Ra). The halogens may include fluorine (F), chlorine (Cl), bromine (Br), iodine (I), and astatine (At). In at least one embodiment, the alkaline earth metal may be calcium and/or magnesium. In at least one embodiment, the halogen may be fluorine (F) or chlorine (Cl). Mixtures may be formed of two or more of any combination of the above. For example, the mixture may include MgF₂ and CaF₂.

The insulating layers 24 may also include compounds having a formula of MH₃, such as trifluorides, where M is metal having a +3 oxidation state and H is a halogen. Compounds having a formula of MH₄ may also be included, wherein the metal has a +4 oxidation state. Examples of M metals may include aluminum, iron, zirconium rare earth elements, or other metals in the aluminum and scandium columns of the periodic table. These compounds may be mixed with AH₂ compounds, described above.

In addition to the above compounds, the mixture may include one or more compounds including an alkali metal and a halogen. The alkali metals may include lithium (Li), sodium (Na), potassium (K), rubidium (Rb), or cesium (Cs). Accordingly, the mixture may include compounds such as LiF, NaF, KF, LiCl, NaCl, KCl, or any other combination. These compounds may have a formula of BH, where B is an alkali metal and H is a halogen.

The above compounds may be mixed in any combination to form binary, ternary, or quaternary systems, or more (e.g., systems having 2, 3, 4, or more components). The systems may include all one type of compound (e.g., a binary or ternary system with all alkaline earth metal-halogen or all alkali metal-halogen compounds), such as a MgF₂ and CaF₂ binary system or a LiF—NaF—KF ternary system. Or, the systems may be mixed, such as a binary system with an alkaline earth metal-halogen and an alkali metal-halogen compound or a ternary system with two of one and one of the other. Similarly, metal-halogen compounds may be incorporated into any of the above.

A phase diagram showing a mixture of AlF₃ and CaF₂ is shown in FIG. 4. The eutectic temperature for this system is about 836° C., which is much lower than either of the individual melting points of 1410° C. (CaF₂) and 1291° C. (AlF₃). The eutectic composition is about 37.5 mol. % AlF₃.

These binary, ternary, quaternary, or more, systems may be eutectic systems. The overall composition used for the insulating material mixture may be at or near to the eutectic point such that the melting point of the mixture is reduced compared to the constituent components. For example, the composition may be within a certain molar ratio of the eutectic point, such as 5%, 10%, 15%, 20%, 25%, or 30%. This is most simply described for a binary system, such as AlF₃ and CaF₂. The eutectic point of this system is at approximately 37.5 mol. % AlF₃ and 62.5% CaF₂, therefore for a composition that is within 10% of the eutectic point, the composition may be from 27.5% to 47.5% AlF₃ and 52.5% to 72.5% CaF₂. The same may apply to other binary systems or to ternary or quaternary systems. In one embodiment, for the AlF₃ and CaF₂ binary system, the composition of the mixture may be from 30% to 60% AlF₃ by molar ratio and 40% to 70% CaF₂ by molar ratio.

As described above, even if the composition of the mixture is not a eutectic composition, there may still be melting at the surface of the particles or powders at temperatures below the melting point. Accordingly, even relatively small amounts of a second or additional compound may improve the sintering. Therefore, the composition may include at least 5 molar % of a second or additional compound, for example at least 10 molar %, 15 molar %, 20 molar %, or 25 molar %. The second or additional compound may be either of the compounds in a binary system. For example, if the second compound is present at 10 molar % in the AlF₃ and CaF₂ system, the composition may be either 10 molar % AlF₃ or 20 molar % CaF₂. The same may apply to other binary systems or to ternary or quaternary systems.

Stated another way, the overall composition used for the insulating material mixture may be at or near to the eutectic point such that the melting point of the mixture at or near the eutectic point temperature. For example, the composition may be configured such that the melting point is within a certain temperature of the eutectic point temperature, such as within 5° C., 10° C., 25° C., 50° C., 75° C., or 100° C. Accordingly, if the composition is configured to have a melting point that is within 50° C. of the eutectic point temperature for a mixture of AlF₃ and CaF₂ (eutectic point of 836° C.), then the composition may have a melting point of 786° C. to 886° C. However, since the eutectic point typically represents a minimum melting point (or at least a local minimum), the composition may have a melting point of the eutectic point temperature (836° C.) to 886° C.

Depending on the composition of the mixtures used for the insulating layers, the melting point may vary. The composition of the insulating material mixture may be configured such that the melting point may be less than or equal to 1100° C., 1050° C., or 1000° C., for example, from 800° C. to 1100° C., 850° C. to 1000° C., 800° C. to 950° C., 850° C. to 950° C., 800° C. to 900° C., 900° C. to 1000° C., 950° C. to 1000° C., 800° C. to 875° C., or 800° C. to 850° C. The melting point of the mixture may be less than a sintering temperature of the magnetic material. In one embodiment, the sintering temperature of the magnetic material may be from 1000° C. to 1100° C., for example 1025° C. to 1075° C. or about 1060° C. The melting point of the insulating layers may be at or near the annealing temperature of the magnet layers 22. For example, the melting point may be within (e.g., ±) 10° C., 25° C., 50° C., 75° C., or 100° C. of the annealing temperature. Therefore, if the annealing temperature is 900° C., and the melting point is within 25° C., the melting point may be from 875° C. to 925° C. Similarly, the annealing temperature may be within (e.g., ±) 10° C., 25° C., or 50° C. of the melting temperature. As described above, even if the composition of the mixture is not a eutectic composition (e.g., about 1:1 molar ratio for MgF₂ and CaF₂ and 37.5 mol. % AlF₃ for AlF₃ and CaF₂), there may still be melting at the surface of the particles or powders, thereby improving materials transport and densification during sintering.

By reducing the melting temperature of the insulating layer material, the insulating layer may at least partially melt during an annealing heat treatment after the magnet layers 22 and insulating layers 24 have been assembled. This melting may increase the adhesive force between the magnet and insulating layers, while also enhancing diffusion between the layers. This mat allow that “gluing” (e.g., joining) of the magnetic layers 22 and the annealing of the magnetic layer 22 to be performed in a single step. This step may include the application of pressure, for example perpendicular to the stacked layers. The pressure may be increased if the melting temperature of the insulating layers 24 is higher than the annealing temperature. In contrast, if the melting temperature of the insulating layers 24 is lower than the annealing temperature, the pressure may be reduced or, in some embodiments, eliminated.

In at least one embodiment, the insulating layers 24 may include one or more rare earth elements (REE), rare earth alloys (REA), or rare earth compounds (REC). Rare earth elements may include cerium (Ce), dysprosium (Dy), erbium (Er), europium (Eu), gadolinium (Gd), holmium (Ho), lanthanum (La), lutetium (Lu), neodymium (Nd), praseodymium (Pr), promethium (Pm), samarium (Sm), scandium (Sc), terbium (Tb), thulium (Tm), ytterbium (Yb), and yttrium (Y), which include light and heavy rare earth elements. Rare earth alloys may include any alloy including at least one rare earth element, and may include non-REE. Similarly, rare earth compounds may include any compound including at least one rare earth element, and may include non-REE. Examples of potential rare earth alloys may include NdCu, NdAl, DyCu, NdGa, PrAl, PrCu, and/or PrAg. The rare earth alloys may include one or more REE and one or more of copper, aluminum, gallium, or silver. The REE, REA, and/or REC may be mixed with the other materials disclosed above with respect to the insulating layers 24. For example, the insulating layers 24 may include MgF₂ and CaF₂ and NdCu or AlF₃ and CaF₂ and NdAl.

The REE, REA, or REC may act as a sort of glue or binder when mixed with the insulating materials. The overall melting point of the insulating layers 24 including the rare earth elements may also be within the ranges disclosed above. When melting or partial melting of the insulating layers occurs, the rare earth elements in the insulating layers 24 may diffuse into the magnetic layers 22. As described previously, the surfaces of the sectioned magnetic layers may have significant damage from the sectioning process. The diffusion of the rare earth elements from the insulating layers 24, such as Nd, may “heal” the magnet layers 22 by increasing the concentration of Nd at the surface of the magnet. Nd-rich phases are very important to the coercivity of Nd—Fe—B magnets; therefore, increasing the Nd at the surface may increase the coercivity at the surface of the magnet layers 22. The rare earth alloys having a low melting point may allow for enhanced diffusion of the rare earth elements to the surface of the magnet layers 22.

While adding rare earth elements/alloys/compounds may improve the magnetic properties and the bond between the magnetic and insulating layers, they typically have very low electrical resistance, and including them in an insulating layer may be counter to the purpose of the insulating layer. However, it has been discovered that the conductivity of a mixture of metallic and dielectric materials may be governed by the percolation theory. Therefore, the conductivity of the insulating layers can be modulated by controlling the amount of metal or alloy powders in the mixture. When the volume ratio of the metallic component is less than a threshold value, the conductivity of the mixture may be close to zero. When the volume ratio of the metallic component is above the threshold value, approximately, conductivity of the mixture of a dielectric and a metallic component can be expressed as:

σ˜(p−p_{c})^{μ}

Where μ is the critical exponent which describes the behavior of the conductivity with varying volume ratio of metal and insulating materials, p can be seen as the volume ratio of the metallic component, and p_{c} is the threshold value indicating the formation of long range connectivity of metal phase. Therefore, rare earth elements/alloys/compounds may be mixed with insulating powders up to a certain amount to improve the mechanical and/or magnetic properties of segmented magnet layers but without increasing the conductivity to an unacceptable level. If the ratio of the metallic powders is below the threshold, the insulating layer would be still dielectric. If a certain level of electrical conductivity is acceptable, the fraction of the rare earth elements may be increased until that level is reached. For example, it has been discovered that at a weight ratio of 20 wt. %, the resistivity of the insulating layer may still be up to 1.5×10⁵ ∩·cm. In one embodiment, the REE, REA, and/or REC may comprise from 1 to 30 wt. % of the insulating layers 24, or any sub-range therein. For example, the REE, REA, or REC may comprise from 5 to 30 wt. %, 5 to 25 wt. %, 10 to 25 wt. %, 15 to 25 wt. %, or about 20 wt. % (e.g., ±5 wt. %).

With reference again to FIG. 3, a segmented sintered magnet 20 is shown in cross-section. The magnet 20 may have a plurality of magnetic layers 22 and one or more insulating layers (IL) 24. The insulating layers 24 may be disposed between magnetic layer 22 to increase the electrical resistance of the magnet 20 and decrease eddy current losses. The insulating layers 24 may be in direct contact with two spaced apart and opposing magnetic layers 22. The magnetic and/or insulating layers 24 may have a uniform or substantially uniform thickness (e.g., within 5% of the average thickness). There may be a plurality of insulating layers 24, for example, one insulating layer 24 between each pair of adjacent magnetic layers 22. In one embodiment, if there are “x” magnetic layers 22, then there may be “x−1” insulating layers 24. In the example shown in FIG. 3, there are three magnetic layers 22 and two insulating layers 24, however, there may be any suitable number of each layer. The magnet may include at least two magnetic layers 22, such that they are separated by an insulating layer 24. But, there may be 3, 4, 5, 10, or more magnetic layers 22, which may include corresponding, 2, 3, 4, 9 or more insulating layers 24 disposed between each pair of magnetic layers 22.

In at least one embodiment, the insulating layer(s) 24 may be relatively thin. For example, the insulating layer(s) 24 may have a thickness (e.g., average thickness) of 1 to 1,000 μm, or any sub-range therein. In one embodiment, the insulating layers 24 may have a thickness of 5 to 500 μm, 5 to 300 μm, 5 to 200 μm, 5 to 150 μm, 5 to 100 μm, 5 to 50 μm, 5 to 25 μm, 10 to 500 μm, 10 to 250 μm, 10 to 150 μm, 25 to 250 μm, 25 to 150 μm, 50 to 150 μm, 50 to 100 μm, or 25 to 100 μm. However, thicknesses outside of these ranges may also be possible. In one embodiment, the thickness may be thick enough to provide a continuous layer of resistive material despite the surface roughness of the magnetic layers 22.

To form the magnet 20, a bulk magnet that has previously been sintered may be cut, sectioned, or otherwise divided into thinner pieces or layers 22. Depending on the roughness of the layers, there may be a polishing or grinding step after sectioning. The bulk magnet may be a rare earth magnet, such as a Nd—Fe—B or Sm—Co magnet. After the layers 22 are formed, an insulating layer 24 may be applied, deposited, or disposed on a magnet layer 22. The insulating layer 24 may include a mixture of materials, which may include insulating materials and “glue” materials, described above. For example, the insulating materials may include AH₂ and/or MH₃ materials, such as Ca/MgF₂ and/or AlF₃. As described above, these mixtures may have reduced melting points compared to their individual constituents.

The insulating layers 24 may be applied as a powder, a suspension, a spray, a liquid, a sheet, a green compact, or any other suitable form. For example, if the layer is applied as a powder, the magnet layers 22 may be placed in a mold and the insulating powder may be deposited on top of or over a magnet layer. The powder may be leveled, pressed, or otherwise made uniform before another magnet layer 22 is placed on top of or over the insulating powder layer. These steps may be repeated until a desired number of insulating layers 24 separate a desired number of magnet layers 22.

Once the stack of magnet layers 22 and insulating layers 24 has been formed, a coalescence process may be performed. This process may include heating the magnet stack and, optionally, applying pressure (e.g., perpendicular to the stacked layers, as shown). This process may be performed at the same temperature and/or time as the conventional annealing process, and therefore may replace the annealing process. In the disclosed magnet stack, the heat treatment may also cause the sintered magnetic layers 22 and the un-sintered insulating layers 24 to bond to each other. The bonding may occur through diffusion, due to the heat treatment occurring at or near the melting point of the insulating material. In at least one embodiment, the bonding occurs without any adhesive or resin, such as polymers or epoxies. The insulating layer may, in one embodiment, consist of only inorganic materials (e.g., ceramics) and metal(s).

The REE, REA, or REC on or near the sectioned surfaces of the magnet may “heal” the damage generated in the surfaces of the magnetic layers 22 as a result of the sectioning process. Rare earth elements, such as Nd, may diffuse from the insulating materials to the surface of the magnetic layers 22, thereby increasing the amount of Nd-rich phase at the surface and increasing the coercivity of the layers. Pressure may also be applied to improve the bond between the insulating layers and the magnetic layers. Higher pressures may be applied if the insulating materials have a melting point higher than the heat treatment temperature. Lower pressures (or no pressure) may be applied if the insulating materials have a melting point at or lower than the heat treatment temperature.

The disclosed magnets may be used in any magnetic application where hard/permanent magnets are used. The magnets may be beneficial where eddy currents are generated. In one embodiment the magnets may be used in electric motors or generators, such as those used in hybrid or electric vehicles. The disclosed magnets and methods of forming the same may decrease the temperature of the magnet, such that lower coercivity is required for the magnet. Therefore, less HRE materials are needed, which reduces costs of electric motors. It also saves energy, which may increase the MPG (miles/gallons) or electric range of electrical vehicles.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A segmented magnet, comprising:
a first layer of permanent magnetic material;
a second layer of permanent magnetic material; and
an insulating layer separating the first and second layers and including a rare earth element and a ceramic mixture including at least first and second ceramic materials.

2. The magnet of claim 1, wherein the ceramic mixture has a melting point that is lower than a melting point of each of the first and second ceramic materials.

3. The magnet of claim 1, wherein the first or second ceramic material includes a compound having a formula of AH₂, where A is an alkaline earth metal and H is a halogen.

4. The magnet of claim 1, wherein the first or second ceramic material includes a compound having a formula of MH₃, where M is metal having a +3 oxidation state and H is a halogen.

5. The magnet of claim 1, wherein the first or second ceramic material includes a compound having a formula of BH, where B is an alkali metal and H is a halogen.

6. The magnet of claim 1, wherein the ceramic mixture has a melting point that is less than or equal to 1,000° C.

7. The magnet of claim 1, wherein the rare earth element is part of a rare earth alloy or a rare earth compound.

8. The magnet of claim 7, wherein the rare earth alloy includes one or more of NdCu, NdAl, DyCu, NdGa, PrAl, PrCu, or PrAg.

9. The magnet of claim 1, wherein the rare earth element comprises up to 20 wt. % of the insulating layer.

10. The magnet of claim 1, wherein the permanent magnetic material in the first and second layers is a Nd—Fe—B magnet and the rare earth element in the insulating layer is Nd.

11. A method of forming a segmented magnet, comprising:
applying an insulating layer to a first sintered permanent magnet layer, the insulating layer including a rare earth element and a ceramic mixture including at least first and second ceramic materials;
stacking a second sintered permanent magnet layer in contact with the insulating layer and spaced from the first sintered permanent magnet layer to form a magnet stack; and
heating the magnet stack.

12. The method of claim 11, wherein the first and second ceramic materials are selected from a group consisting of:
a compound having a formula of AH₂, where A is an alkaline earth metal and H is a halogen;
a compound having a formula of MH₃, where M is metal having a +3 oxidation state and H is a halogen; and
a compound having a formula of BH, where B is an alkali metal and H is a halogen.

13. The method of claim 11, wherein the ceramic mixture has a melting point that is lower than a melting point of each of the first and second ceramic materials.

14. The method of claim 13, wherein the heating step includes annealing the magnet stack at an annealing temperature within 100° C. of the melting point of the ceramic mixture.

15. The method of claim 11, further comprising applying pressure to the magnet stack during the heating step.

16. The method of claim 11, further comprising sectioning the first and second sintered permanent magnet layers from a bulk sintered magnet prior to the applying step.

17. The method of claim 11, wherein the rare earth element comprises up to 30 wt. % of the insulating layer.

18. A segmented magnet, comprising:
a first layer of permanent magnetic material;
a second layer of permanent magnetic material; and
an insulating layer separating the first and second layers and including:
a rare earth element; and
a ceramic mixture including at least two ceramic materials in a eutectic system, the ceramic mixture having a melting point that is within 100° C. of a eutectic point temperature of the eutectic system.

19. The magnet of claim 18, wherein the eutectic system is a binary, ternary, or quaternary system.

20. The magnet of claim 18, wherein at least one of the at least two ceramic materials is selected from a group consisting of:
a compound having a formula of AH₂, where A is an alkaline earth metal and H is a halogen;
a compound having a formula of MH₃, where M is metal having a +3 oxidation state and H is a halogen; and
a compound having a formula of BH, where B is an alkali metal and H is a halogen.
